(19) United States
(12) Patent Application Publication
(10) Pub. No.: US 2003/0033306 A1
(43) Pub. Date: Feb. 13, 2003

(54) Information transacting and updating mechanism

(76) Inventor: Yih-Ping Luh, Taipei (TW)

Correspondence Address: WEI TE CHUNG, FOXCONN INTERNATIONAL, INC., 1650 MEMOREX DRIVE, SANTA CLARA, CA, 95050, US

(21) Appl. No.: 09/925,126

(22) Filed: Aug. 8, 2001

(51) Int. Cl. G06F 7/00; G06F 17/30

(52) U.S. Cl. 707/10

(57) ABSTRACT

An information transacting mechanism between a provider and a customer is provided. The information transacting mechanism comprises an information server controlled by the provider. An original information box is extracted from the information server. A tool server provides tools when instructed by the provider. A tool-added information box is resulted from the original information box by packing tools therein via the tool server and sent to the customer for the customer to access the data contained in the tool-added information box.

### BACKGROUND OF THE INVENTION

1. Field of the Invention

The present invention relates to an information transacting and updating mechanism between remote parties, especially an information transacting and updating mechanism utilizes decomposing and packing techniques for speeding transfer and update of data between the remote parties.

2. The Prior Art

In the internet era, data sharing is important in different applications such as the on-line game, the net conference, and the supply chain because users of the above applications need to know the updated data from others as soon as possible. Conventionally, the updated data of a first party needs to be transferred to a second party for immediate reference. Similarly, the updated data of the second party may have to be transferred to the first party for immediate reference. For transferring updated data between two parties, a large amount of images, data frames, and data have to be transferred and duplicated between the two parties. With this mechanism, most data or images are repeatedly transferred and duplicated thus wasting time. These repeatedly transferred images, data frames, and data not only occupy the bandwidth of a transferring path but also slow down the information updating thus affecting normal operations of the two parties. Therefore, it is requisite to provide a new mechanism and method for effectively minimizing the redundant transferring and updating of the information.

### SUMMARY OF THE INVENTION

A primary purpose of the present invention is to provide an information transacting mechanism between an information provider and a customer for more effectively transferring and updating the required information.

A secondary purpose of the present invention is to provide an information transacting mechanism between an information provider and a customer for selectively limiting the authority of the customer.

One aspect of the present invention is to provide an information transacting mechanism between an information provider and a customer. The information transacting mechanism comprises a host database, an original information box extracted from the host database and transferred to the customer via e-mail. A first transacted information box is modified from the original information box by the customer and then sent to the provider via e-mail. A second transacted information box is modified from the first transacted information box by the provider and then sent to the customer via e-mail.

Another aspect of the present invention is to provide an information transacting mechanism between an information provider and a customer. The information transacting mechanism comprises an information server controlled by the information provider. An original information box is extracted from the information server. A tool server is installed with a plurality of tools by an application service provider and provides tools when instructed by the application service provider. A tool-added information box is resulted by packing the original information box with tools of the tool server and sent to the customer for the customer to access the data contained in the tool-added information box.

### BRIEF DESCRIPTION OF THE DRAWINGS

FIG. 1A is a schematic view in accordance with the present invention showing a relational database being decomposed into several partitions;

FIG. 1B is a schematic view in accordance with the present invention showing a set of tools stored in a tool server being decomposed into several tool modules;

FIG. 1C is a schematic view in accordance with the present invention showing partitions extracted from the relational database and tool modules decomposed from the tool server being encapsulated in a box;

FIG. 2 is a first embodiment of an information transacting mechanism between a host database and a remote end user in accordance with the present invention;

FIG. 3 is a schematic data frame used in an original information box of FIG. 2;

FIG. 4 is a second embodiment of an information transacting mechanism in accordance with the present invention;

FIG. 5 is a third embodiment of an information transacting mechanism in accordance with the present invention; and

FIG. 6 is a fourth embodiment of an information transacting mechanism in accordance with the present invention.

### DETAILED DESCRIPTION OF THE PREFERRED EMBODIMENT

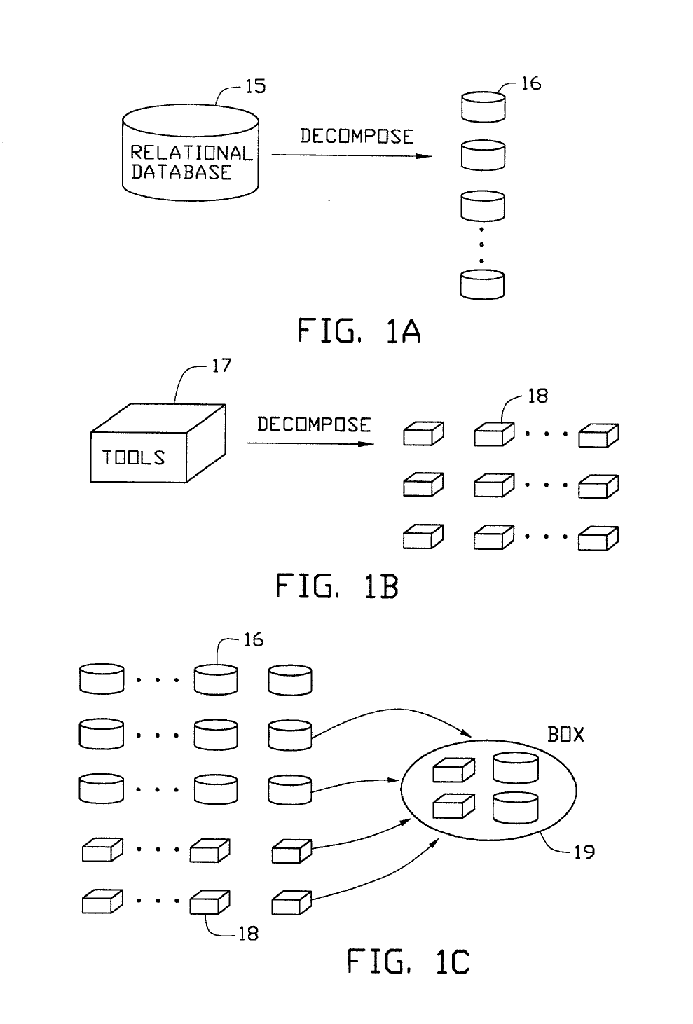

Referring to FIG. 1A, a relational database 15 may be virtually decomposed into several partitions 16 according to predetermination of an information provider. Referring to FIG. 1B, a set of tools 17 for providing accessing functions to the partitions 16 such as “view” “delete”, “update” may be physically decomposed into respective functional tool components 18. Referring to FIG. 1C, the database partitions 16 and the functional tool components 18 may be selectively packed in a box 19 so that the specific database partitions 16 may be configured with specific functional tool components 18 allowing a customer to access the data contained therein upon receipt of the box 19. This is the software decomposition technique used in the present invention and it results in different embodiments described subsequently.

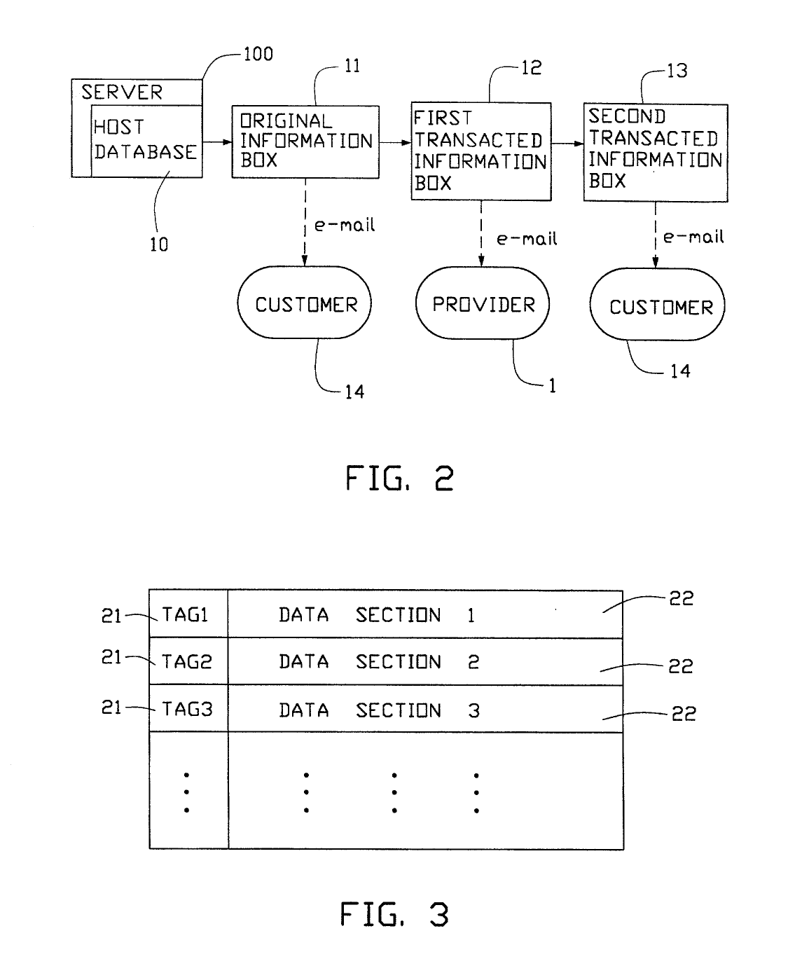

Referring to FIG. 2, a first embodiment of an information transacting mechanism between a host database and a remote end user is disclosed. The information transacting mechanism comprises a host database 10 installed in a server 100 which is maintained by an information provider 1 (herein simplified as provider). An original information box 11 is extracted from the host database 10 and transferred to a customer 14 via e-mail. The original information box 11 is a subset of the host database 10. The original information box 11 is a practical guide for the customer 14 to input his customized data. With the customized data, the provider 1 may correspondingly “answer” questions of the customer. When the customer receives the original information box 11, he/she can input specific data to replace corresponding original data without changing the format of the original information box 11. The specific data inputted by the customer 14 are called modified portion hereinafter. Therefore, a first transacted information box 12 is modified from the original information box 11 by the customer 14 according to his/her specific needs and then sent to the provider 1 via e-mail. A second transacted information box 13 is modified from the first transacted information box 12 by the provider 1 and then sent to the customer 14 by e-mail. The provider 1 provides the requested information in the second transacted information box 13 to the customer 14 according to the modified portion inputted by the customer 14 thereby answering the customer's requirement.

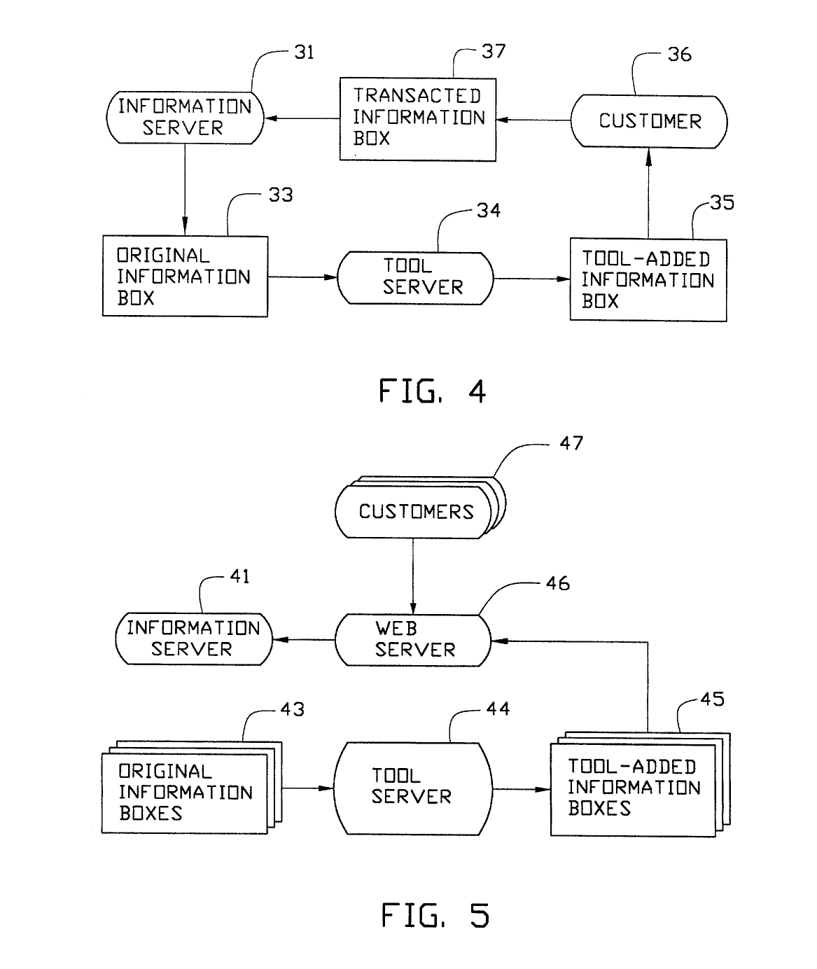

Referring to FIG. 3, the original information box 11 contains many data sections 22, for example, DATA SECTION 1, DATA SECTION 2, and DATA SECTION 3, and each data section 22 is associated with an identification tag 21, for example, TAG 1, TAGE 2, and TAG 3. These tags 21 are logic flags which indicate whether the corresponding data sections 22 have been rewritten.

The provider 1 will know the modified portions based on the identification tags 21, upon receipt of the first transacted information box 12. The provider 1 will modify the data stored in the first transacted information box 12 according to the modified data inputted by the customer 14. Therefore, answers inputted by the provider 1 corresponding to the inputted data by the customer 14 are together finalized in the second transacted information box 13 and shared by the provider 1 and the customer 14. With this mechanism, an interactive database updating can be performed between the provider 1 and the customer 14.

A second embodiment is modified from the first embodiment and shown in FIG. 4. The mechanism comprises an information server 31 which is controlled by an information provider. An original information box 33 is extracted from the information server 31 which only contains data while not contains necessary tools to access the data. The original information box 33 is packed with tools by a tool server 34 owned by an application service provider and changed to be a tool-added information box 35 and sent to a customer 36 via e-mail from the application service provider. Specifically, the tool server 34 may pack different tools into the original information box 33 based on instructions from the application service provider. For example, the tool server 34 may comprise a read tool, a delete tool, a write tool and an authority setting tool. The read tool allows the customer 36 to read the information contained in the original information box 33. The delete tool allows the customer 36 to delete information contained in the original information box 33. The write tool allows the customer 36 to modify the information contained in the original information box 33. The authority setting tool allows the customer 36 to set authority levels for a subsequent customer (not shown) to either read-only or modify the data contained in the tool-added information box 35 passed by the previous customer 36.

A transacted information box 37 is resulted after the customer 36 has modified the data contained in the tool-added information box 35. The transacted information box 37 is then sent back to the information server 31 for updating via e-mail. The information server 31 has the right to determine whether to accept the update or not. This updating mode is called a copied mode.

Referred to FIG. 5, a third embodiment of the mechanism is used in a web site and modified from the second embodiment. The mechanism comprises an information server 41 controlled by an information provider (not shown). Different original information boxes 43 are extracted from the information server 41 and each specific original information box 43 only contains data while not contains necessary tools to access the data. Each original information box 43 contains specific information according to predetermination of the information provider. Each original information box 43 is packed with tools by a tool server 44 owned by an application service provider and changed to be a tool-added information box 45 and sent to a web server 46 via internet. Different customers 47 may visit a web page (not shown) associated with the web server 46 thereby selectively obtaining the tool-added information box 45 meeting respective needs. The customers 47 can modify the data based on the tools provided in the information box 45 and the transacted data in each information box 45 may be sent back to the information server 41 for updating.

In this embodiment, there are two modes for updating the data of the information server 41. The first mode is called a master-slave mode by which the information server 41 will be automatically updated whenever it detects and receives the transacted data. The second mode is called a replication mode by which the transacted data performed by different customers are put into a queue first and then update the information server 41 sequentially.

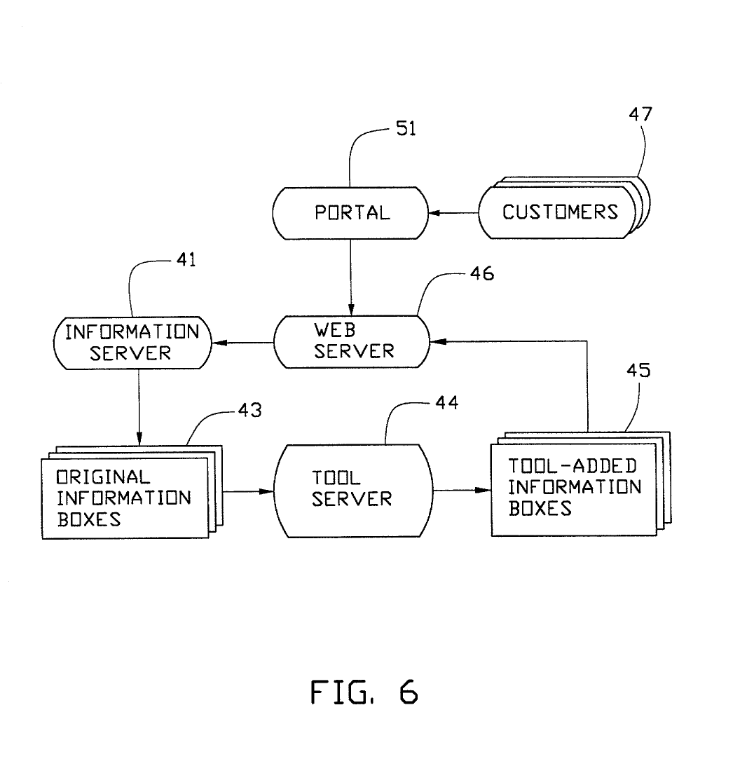

The mechanism of FIG. 5 can be further extended into a fourth embodiment used for a web portal run by an internet content provider. Referring to FIG. 6, a portal 51 is additionally interconnected between the web server 46 and the customers 47 of FIG. 5, while other functional components and their relations are identical to those described in FIG. 5 thus the description thereof is omitted herein. This mechanism can serve for those customers not aware of the web server 46 but only aware of the portal 51. Therefore, the internet content provider owning the portal 51 can utilize this mechanism for practicing a business model. For example, the internet content provider can link to different kinds of information servers via this mechanism thereby providing a platform for categories of information services.

While the present invention has been described with reference to a specific embodiment, the description is illustrative of the invention and is not to be construed as limiting the invention. Therefore, various modifications to the present invention can be made to the preferred embodiment by those skilled in the art without departing from the true spirit and scope of the invention as defined by the appended claims.

What is claimed is:

1. An information transacting mechanism between an information provider and a customer, the information transacting mechanism comprising a host database, an original information box extracted from the host database and transferred to the customer via email, a first transacted information box which is modified from the original information box by the customer and then sent to the provider via e-mail, a second transacted information box which is modified from the first transacted information box by the provider and then sent to the customer via e-mail.

2. The information transacting mechanism as claimed in claim 1, wherein the original information box contains a plurality of data sections each of which is associated with an identification tag for indicating whether the corresponding data section has been rewritten.

3. An information transacting mechanism between an information provider and a customer, the information transacting mechanism comprising:
an information server controlled by the information provider;
an original information box extracted from the information server;
a tool server installed with a plurality of tools by an application service provider and providing tools when instructed by the application service provider; and
a tool-added information box being resulted by packing the original information box with tools of the tool server and sent to the customer for the customer to access the data contained in the tool-added information box.

4. The transacted information box as claimed in claim 3 further comprising a transacted information box which is resulted from the tool-added information box accessed and modified by the customer and sent from the customer back to the information server for updating the information server.

5. An information transacting mechanism between an information provider and a plurality of customers, the information transacting mechanism comprising:
an information server which is controlled by the information provider;
an original information box selectively extracted from the information server by the information provider;
a tool server providing tools for accessing information stored in the original information box;
a tool-added information box resulted from the original information box by packing tools therein via the tool server;
a web server for storing the tool-added information box and allowing customers to access the tool-added information box after payment.

6. An information transacting mechanism between an internet content provider and a plurality of customers, the information transacting mechanism comprising:
an information server which is controlled by an original information provider;
an original information box selectively extracted from the information server by the original information provider;
a tool server providing tools for accessing information stored in the original information box;
a tool-added information box resulted from the original information box by packing tools therein via the tool server; and
a web server for storing the tool-added information box, the web server being linked to a portal which is owned by the internet content provider so that customers can access the tool-added information box stored in the web server by visiting the portal.

7. A method of allowing a customer to access and modify a specific database, the steps comprising:
providing a relational database;
decomposing said database into several partitions according to customer levels;
providing a set of tools with accessing functions to the corresponding partitions;
decomposing said set of tools into respective functional tool components;
packing selected partitions and functional tool components in one box file; and
sending this packed box file to a customer meeting the customer level of the selected partitions for allowing the customer to accessibly modify and/or update said partitions.
